(19) United States
(12) Patent Application Publication
(10) Pub. No.: US 2022/0343132 A1
(43) Pub. Date: Oct. 27, 2022

(54) METHOD FOR CONTROLLING VIRTUAL PETS, AND SMART PROJECTION DEVICE

(71) Applicant: IVIEW DISPLAYS (SHENZHEN) COMPANY LTD., Shenzhen (CN)

(72) Inventors: Shihao Chen, Shenzhen (CN); Mingnei Ding, Shenzhen (CN); Wenxiang Li, Shenzhen (CN); Steve Yeung, Hongkong (CN); Zhiqiang Gao, Hongkong (CN)

(21) Appl. No.: 17/739,258

(22) Filed: May 9, 2022

Related U.S. Application Data
(63) Continuation of application No. PCT/CN2021/106315, filed on Jul. 14, 2021.

(30) Foreign Application Priority Data
Apr. 26, 2021 (CN) 202110454930.4

(51) Int. Cl. G06N 3/00; G06F 3/01; G10L 15/22

(52) U.S. Cl. CPC G06N 3/006; G06F 3/017; G10L 15/22; G06F 3/011

(57) ABSTRACT

Embodiments of the present disclosure provide a method for controlling virtual pets and a smart projection device. The method is applicable to the smart projection device. The smart projection device may project the virtual pets to the real space, display the same in a predetermined style, and may change different styles at will, such that the user may obtain the experience of raising different pets. In addition, the smart projection device may also receive the instruction information from the user, and control the virtual pets to conduct corresponding interaction behaviors according to the instruction information.

### CROSS-REFERENCE TO RELATED APPLICATION

This application is based upon and claims priority to Chinese Patent Application No. 2021104549304, filed before China National Intellectual Property Administration on Apr. 26, 2021 and entitled “METHOD FOR CONTROLLING VIRTUAL PETS, AND SMART PROJECTION DEVICE,” the entire contents of which are incorporated herein by reference.

### TECHNICAL FIELD

Embodiments of the present disclosure relate to the technical field of smart devices, and in particular, relate to a method for controlling virtual pets, and a smart projection device.

### BACKGROUND

With the development of society, people's work and life are in a faster and faster pace, mental stress is also increasing, and people are lacking accompanying and becoming lonely. Therefore, raising pets may help people to regulate mood and increase enjoyment for their life. However, most people do not have enough time and energy to take care of the pets, which results in abandonment of raising pets.

At present, electronic game pets on the market are too limited and may only run on electronic screens, for example, mobile phones, computers, and the like. In addition, the pets cannot move or walk in a real space, and fail to interact with a real world. Such game pets are much more different from and comparable to home-raised pets. Although some AI robot pets can walk in the real space, they are too expensive, and actions and expressions are too simple.

### SUMMARY

In a first aspect, the embodiments of the present disclosure provide a method for controlling virtual pets, which is applicable to a smart projection device. The method includes:

presetting a virtual pet, and controlling the smart projection device to project the virtual pet in a real space; and

receiving instruction information from a user, and controlling, based on the instruction information, the virtual pet to conduct a corresponding interaction behavior.

In some embodiments, the instruction information includes a user posture; and controlling, based on the instruction information, the virtual pet to conduct the corresponding interaction behavior includes:

controlling the virtual pet to imitate the user posture.

In some embodiments, the instruction information includes a gesture; and controlling, based on the instruction information, the virtual pet to conduct the corresponding interaction behavior includes:

determining, based on the gesture, a first interaction action corresponding to the gesture; and

controlling the virtual pet to conduct the first interaction action.

In some embodiments, the instruction information includes voice information; and controlling, based on the instruction information, the virtual pet to conduct the corresponding interaction behavior includes:

acquiring, based on the voice information, a second interaction action indicated by the voice information; and

controlling the virtual pet to conduct the second interaction action.

In some embodiments, the method further includes:

detecting whether the virtual pet is in touch with the user;

determining, based on a touch position of the virtual pet, a third interaction action corresponding to the touch position in response to detecting that the virtual pet is in touch with the user; and

controlling the virtual pet to conduct the third interaction action.

In some embodiments, the method further includes:

acquiring three-dimensional information of the virtual pet in the real space;

determining, based on the three-dimensional information, a walk path of the virtual pet, and an active range of the virtual pet and an activity item corresponding to the active range; and

controlling the virtual pet to walk along the walk path and conduct the activity item within the active range.

In some embodiments, the method further includes:

identifying a color of a first target object, wherein the first target object is an object which the virtual pet passes by; and

controlling a skin of the virtual pet to exhibit the color of the first target object.

In some embodiments, the method further includes:

identifying an attribute of a second target object, wherein the second target object is an object in a predetermined detection region in the real space; and

controlling, based on the attribute of the second target object, the virtual pet to conduct a fourth interaction action corresponding to the attribute of the second target object.

In a second aspect, the embodiments of the present disclosure provide a smart projection device. The smart projection device includes:

a projecting unit, configured to project a virtual pet to a real space;

a rotating unit, configured to control the projecting unit to rotate to control the virtual pet to move in the real space;

a sensor assembly, configured to acquire instruction information from a user and acquire three-dimensional information of the real space;

at least one processor, communicably connected to the projecting unit, the rotating unit, and the sensor assembly; and

a memory communicably connected to the at least one processor; wherein the memory stores one or more instructions executable by the at least one processor, wherein the one or more instructions, when executed by the at least one processor, cause the at least one processor to perform the method according to the first aspect based on the instruction information and the three-dimensional information of the real space.

In a third aspect, the embodiments of the present disclosure further provide a non-volatile computer-readable storage medium storing one or more computer-executable instructions, wherein the one or more computer-executable instructions, when executed by at least one processor, cause the at least one processor to perform the method according to the first aspect.

The present disclosure may achieve the following beneficial effects: Different from the related art, the method for controlling virtual pets according to the embodiments of the present disclosure is applicable to the smart projection device, and the smart projection device may project the virtual pets to the real space, display the same in a predetermined style, and may change different styles at will, such that the user may obtain the experience of raising different pets; and in addition, the smart projection device may also receive the instruction information from the user, and control the virtual pets to conduct corresponding interaction behaviors according to the instruction information, such that the interactions are more flexible and convenient, and the user may obtain a better experience and more pleasure and have an intimate pet accompanying sense.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic diagram of an application scenario of a method for controlling virtual pets according to an embodiment of the present disclosure;

FIG. 2 is a schematic diagram of a pet feature database according to an embodiment of the present disclosure;

FIG. 3 is a schematic structural diagram of hardware of a smart projection device according to an embodiment of the present disclosure;

FIG. 4 is a schematic flowchart of a method for controlling virtual pets according to an embodiment of the present disclosure;

FIG. 5 is a schematic sub-flowchart of step S22 in the method as illustrated in FIG. 3;

FIG. 6 is another schematic sub-flowchart of step S22 in the method as illustrated in FIG. 3;

FIG. 7 is still another schematic sub-flowchart of step S22 in the method as illustrated in FIG. 3;

FIG. 8 is a schematic flowchart of another method for controlling virtual pets according to an embodiment of the present disclosure;

FIG. 9 is a schematic flowchart of another method for controlling virtual pets according to an embodiment of the present disclosure;

FIG. 10 is a schematic flowchart of another method for controlling virtual pets according to an embodiment of the present disclosure; and

FIG. 11 is a schematic flowchart of another method for controlling virtual pets according to an embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although logic function module division is illustrated in the schematic diagrams of apparatuses, and logic sequences are illustrated in the flowcharts, in some occasions, steps illustrated or described by using modules different from the module division in the apparatuses or in sequences different from those illustrated. Further, the terms “first,” “second,” and “third” used in this text do not limit data and execution sequences, and are intended to distinguish identical items or similar items having substantially the same functions and effects.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

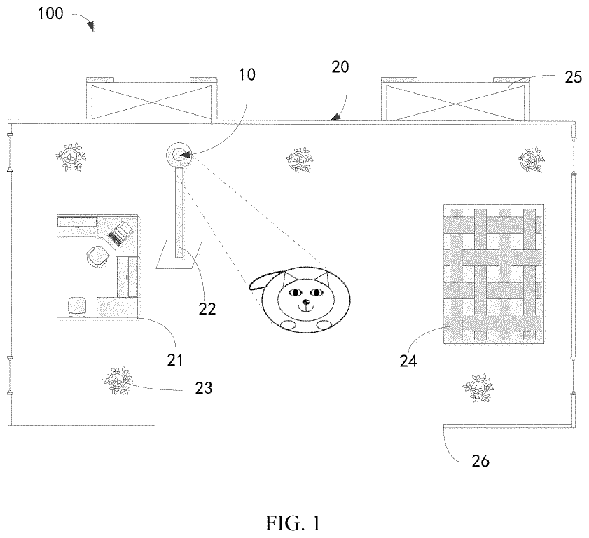

Referring to FIG. 1, a schematic diagram of an application scenario 100 of a method for controlling virtual pets according to an embodiment of the present disclosure is illustrated. As illustrated in FIG. 1, the application scenario 100 includes a smart projection device 10 and a real space 20.

The real space 20 may be a user's living room, office, or the like. For example, the real space 20 as illustrated in FIG. 1 includes a desk area 21, a bracket 22, a flower pot 23, a pet rest area 24, a bay window 25, and a door 26. The smart projection device 10 is placed on the bracket 22. It may be understood that the smart projection device 10 may also be suspended on a ceiling (not illustrated) in the real space, or placed on a desktop. It may be understood that the placement of the smart projection device 10 is not limited as long as the smart projection device can project images in the real space 20, and there is no limitation on the real space 20 as long as the real space 20 is a real environment. The application scenario in FIG. 1 is only illustrated as an example, and such illustration does not constitute any limitation on the application scenario of the method for controlling the virtual pets.

The smart projection device 10 may be an electronic device integrated with a rotating unit, a sensor assembly, a voice module, and a projector, and may run according to a program and process massive data automatically at a high speed. The projector may project the virtual pets to the real space, and the rotating unit may drive the projector to rotate, such that the virtual pets are capable of moving (for example, walking, jumping, or flying), the sensor assembly may perceive the real space (for example, perceiving a sound, a color, a temperature, an object, or the like in the real space), and the voice module may play a voice to enable the virtual pets to make a sound to interact with the user.

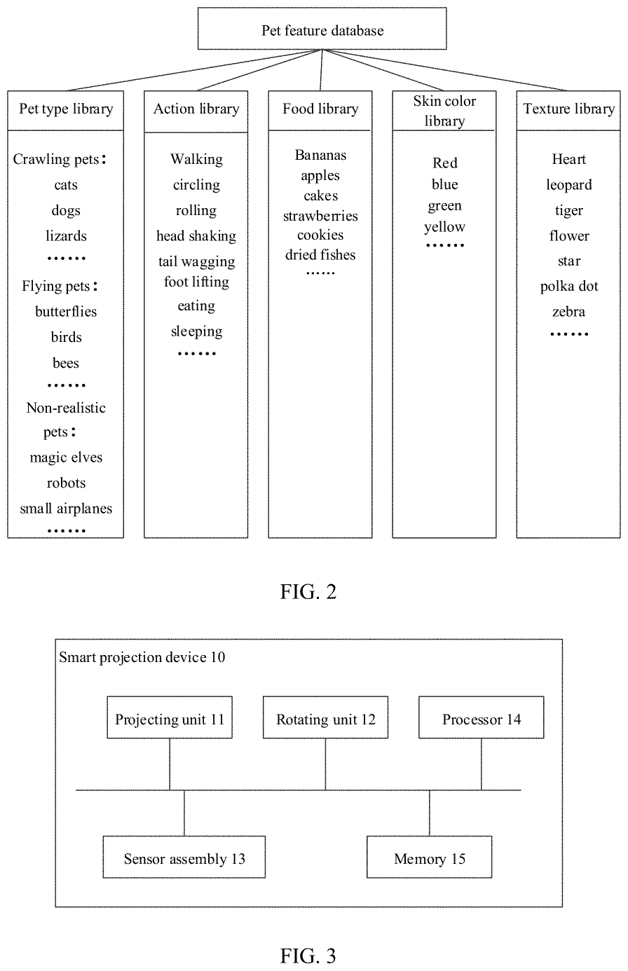

The smart projection device 10 stores a pet feature database. The pet feature database includes a pet type library, an action library, a food library, a skin color library, and a texture library, or the like for defining pet features. As illustrated in FIG. 2, the pet type library includes crawling pets (for example, cats, dogs, lizards, and the like), flying pets (for example, birds, butterflies, bees, and the like), and non-realistic pets (for example, magic elves, robots, and other animation modeling pets). The action library lists the actions that may be conducted by the pets, including, for example, walking, circling, rolling, head shaking, tail wagging, sleeping, and the like. The food library lists foods that are edible by the pets, for example, bananas, apples, cakes, dried fishes, and the like. The skin color library provides optional skins for the virtual pets, for example, red, blue, green, hybrid colors, and the like. The texture library provides optional textures for the virtual pets, for example, heart, leopard, tiger, flower, polka dot, zebra, and the like. In this way, the user may obtain his or her favorite pet appearance by designing skin color and texture. It may be understood that pet types, actions, and foods may also be combined and matched with each other, for example, kittens roll and eat dried fishes. In this way, animals may be simulated more realistically, the virtual pets become animate, and the possibility of raising different pets is achieved by changing the pet types. For example, a lizard is raised in this month, and a dog is raised in a next month. It may be understood that the user may also update and maintain the pet feature database, continuously enrich the pet features, and improve playability of the virtual pets. For example, the user may download feature data from a product official website for updating the pet feature database, and those skilled in the art may also upload the feature data prepared according to open standards to the product official website for the user's download and update.

In the case that the user determines feature parameters from the pet feature database, the virtual pets may be preset. For example, a preset virtual pet is a cat, and the smart projection device 10 may project and display the virtual pet in the real space 20, for example, the cat as illustrated in FIG. 1.

The smart projection device 10 may simulate living states of the virtual pets in the real space in combination with a preset program. For example, the virtual pets are controlled to sleep in the pet rest area 24, play by the bay window 25, or the like, such that the virtual pets are more playable, and the experience is more real.

Since the smart projection device 10 is integrated with the sensor assembly and the voice module, the smart projection device 10 is capable of detecting and identifying the user and the object, and controlling the virtual pets to make real-time feedback according to an actual environment and instructions, for example, user actions, voices, or the like, such that the interactions are flexible, interest is improved, and an intimate pet accompanying sense is created.

Based on FIG. 1 and FIG. 2, a smart projection device is provided according to another embodiment of the present disclosure. Referring to FIG. 3, a schematic structural diagram of hardware of a smart projection device 10 according to an embodiment of the present disclosure is illustrated. Specifically, as illustrated in FIG. 3, the smart projection device 10 includes a projecting unit 11, a rotating unit 12, a sensor assembly 13, at least one processor 14, and a memory 15. The at least one processor 14 is communicably connected to the projecting unit 11, the rotating unit 12, the sensor assembly 13, and the memory 15 (FIG. 3 uses bus connection and one processor as an example).

The projecting unit 11 is configured to project a virtual pet to the real space 20, and the rotating unit 12 is configured to control the projecting unit 11 to rotate to control the virtual pet to move in the real space 20. For example, the rotating unit 12 controls the projection unit 11 to rotate towards the window at a specified speed, and cooperates with cyclic pictures of the virtual pet walking in an original place, such that the effect of the virtual pet walking towards the bay window 25 at the specified speed is achieved. It may be understood that a walking speed of the virtual pet is determined by a moving speed of a projection picture in combination with a frequency stride of a walking animation of the virtual pet, and the walking speed of the virtual pet is proportional to the moving speed of the projection picture.

The sensor assembly 13 is configured to acquire instruction information from the user and acquire three-dimensional information of the real space 20. The sensor assembly 13 includes at least one sensor. For example, the sensor assembly 13 includes a camera, which acquires user gesture or body posture as the instruction information, and identifies the three-dimensional information of the real space (for example, an object, a color, a distance, or the like in the real space) by photographing the real space. Alternatively, the sensor assembly 13 further includes a microphone, which acquires the voice information from the user as the instruction information.

The at least one processor 14 is configured to provide calculation and control capabilities to control the smart projection device 10 to perform corresponding tasks. For example, the smart projection device 10 is controlled to perform any of the methods for controlling the virtual pets according to embodiments of the present disclosure hereinafter based on the above instruction information and the three-dimensional information of the real space.

It should be understood that the processor 14 may be a general purpose processor, including a central processing unit (CPU), a network processor (NP), or the like, or may be a digital signal processor (DSP), an application specific integrated circuit (ASIC), a field-programmable gate array (FPGA), or another programmable logic device, a discrete gate or transistor logic device, or a discrete hardware component.

The memory 15, as a non-transitory computer readable storage medium, may be configured to store non-transitory software programs, non-transitory computer executable programs and modules, for example, the program instructions/modules corresponding to the method for controlling virtual pets according to the embodiments of the present disclosure. The non-transitory software programs, instructions and modules stored in the memory 15, when executed, cause the processor 14 to perform the method for controlling virtual pets according to any one of the method embodiments hereinafter. Specifically, the memory 15 may include a high-speed random access memory, or include a non-transitory memory, for example, at least one disk storage device, a flash memory device, or another non-transitory solid storage device. In some embodiments, the memory 15 may further include memories remotely configured relative to the processor. These memories may be connected to the processor over a network. Examples of the above network include, but not limited to, the Internet, Intranet, local area network, mobile communication network and a combination thereof.

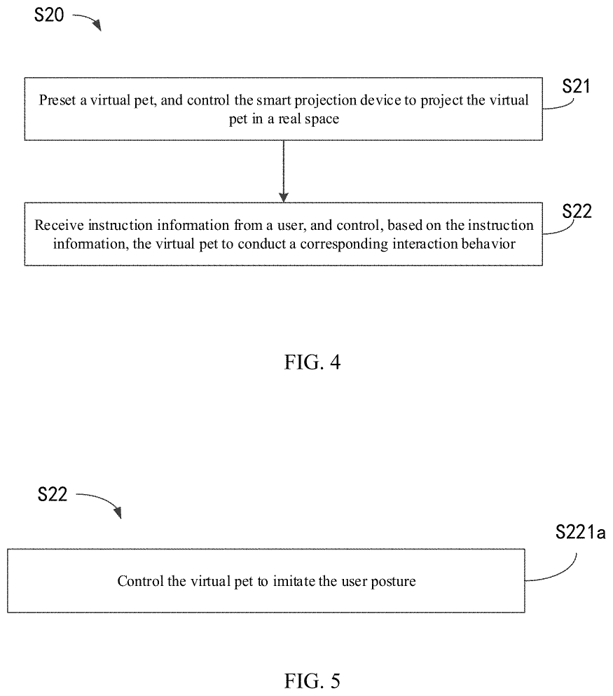

Hereinafter, a method S20 for controlling virtual pets according to the embodiment of the present disclosure is described in detail. Referring to FIG. 4, the method S20 includes, but is not limited to, the following steps.

In S21, a virtual pet is preset, and the smart projection device is controlled to project the virtual pet in a real space.

In S22, instruction information from a user is received, and the virtual pet is controlled, based on the instruction information, to conduct a corresponding interaction behavior.

The smart projection device may preset the virtual pet. That is, the smart projection device acquires features about the virtual pet input by the user based on the above pet feature database, thereby generating the virtual pet. The type, skin color, texture, voice, size, age, and the like of the virtual pet may be defined based on the pet feature database. The types of the virtual pets may include crawling animals, for example, kittens, puppies, lizards, and the like; or may include flying animals, for example, birds, butterflies, bees, and the like; or may include non-realistic characters, for example, animation characters and the like. It may be understood that a default template of the virtual pet may also be defined in the smart projection device, and the user may also directly select the default template as the virtual pet, or customize the default template according to his or her preferences, for example, adjusting skin color, texture, and the like. In this way, the user may often change virtual pets in different styles at will, and obtain an experience of raising different pets. For example, the user raises a magic elf in this month, raises a dog in next month, or the like.

It may be understood that the user may also update and maintain the pet feature database, continuously enrich the pet features, and improve playability of the virtual pets.

In the case that the smart projection device generates a virtual pet, the projector in the smart projection device is controlled to project and display the virtual pet in the real space. That is, an active range of the virtual pet is a projection range of the smart projection device, and the projection range may be moved at will, such that the virtual pet may move in the entire real space. Therefore, the virtual pet is no longer limited to a terminal screen, but is displayed to the side of the user and made active in a real scene, which is more vivid and increases the accompanying sense. In the case that instruction information is not received, the virtual pet enters a free state, that is, the virtual pet may be controlled to walk freely in the real space and conduct free behaviors, for example, eating, dozing, tail wagging, rolling, and the like.

Upon receiving the instruction information from the user, the smart projection device acquires the interaction behaviors corresponding to the instruction information. It may be understood that the smart projection device may be provided with a database, wherein the database pre-stores instruction information and interaction behaviors corresponding to the instruction information. The instruction information and the interaction behaviors corresponding to the instruction information may also be defaulted in the smart projection device, or may be customized by the user according to his or her own hobbies or needs. For example, when the user points to the pet rest area, the virtual pet may enter the pet rest area to sleep, and when the user opens the door, the virtual pet may run to the door to greet the user.

In this embodiment, the smart projection device may project the virtual pet to the real space, display the same in a preset style, and may change different styles at will, such that the user obtains the experience of raising different pets; and in addition, the smart projection device may also receive the instruction information from the user, and control the virtual pets to conduct corresponding interaction behaviors according to the instruction information, such that the interactions are more flexible and convenient, and the user may obtain a better experience and more pleasure and have an intimate pet accompanying sense.

In some embodiments, the instruction information includes a user posture; and referring to FIG. 5, step S22 specifically includes the following steps.

In S221a, the virtual pet is controlled to imitate the user posture.

In this embodiment, the instruction information includes the user posture, that is, a body posture of the user. The smart projection device may capture, using a sensor (for example, a camera), an image (the instruction information) reflecting the user posture, and then acquire the user posture by human body posture identification on the image. It may be understood that the user posture may be acquired by image identification using a trained convolutional neural network or a classification model, for example, a decision tree, an SVM, or the like.

Upon acquiring the user posture, the smart projection device may call an action corresponding to the user posture in a pre-stored pet feature database, and control the projector to project the action of the virtual pet, that is, the virtual pet is controlled to imitate the user posture. For example, taking the virtual pet being a lizard as an example, when the user lifts a right hand, the virtual pet lizard lifts a right front foot, and when user lifts a left foot, the virtual pet lizard lifts a left front foot.

In this embodiment, upon identification of the user posture, the virtual pet is controlled to imitate the user posture, such that the interactions between the virtual pet and the user are realized.

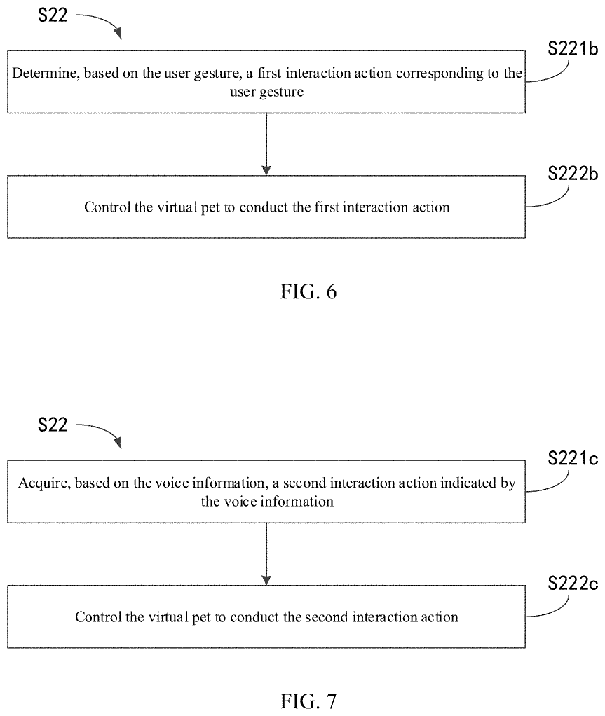

In some embodiments, the instruction information includes a user gesture; and referring to FIG. 6, step S22 specifically includes the following steps.

In S221b, a first interaction action corresponding to the user gesture is determined based on the user gesture.

In S222b, the virtual pet is controlled to conduct the first interaction action.

In this embodiment, the instruction information includes the user gesture. The smart projection device may capture, using a sensor (for example, a camera), an image (the instruction information) reflecting the user gesture, and then acquire the user gesture by gesture identification on the image. It may be understood that the user gesture may be acquired by image identification using a trained convolutional neural network or a classification model, for example, a decision tree, an SVM, or the like.

Upon acquiring the user gesture, the smart projection device may call a pre-stored library storing a mapping relationship between the user gesture and the first interaction action, search for the first interaction action corresponding to the user gesture, and control the virtual pet to conduct the first interaction action. For example, when the user beckons, upon identifying a beckoning gesture, the smart projection device controls the rotating unit to drive the projector to rotate, such that the virtual pet walks from a current position to the user; and when the user waves, upon identifying a waving gesture, the smart projection device controls the rotating unit to drive the projector to rotate, such that the virtual pet leaves from the user.

In this embodiment, the user gesture is identified, and the virtual pet is controlled to conduct the corresponding first interaction action, such that the interactions between the virtual pet and the user are realized.

In some embodiments, the instruction information includes voice information; and referring to FIG. 7, the step S22 specifically includes the following steps.

In S221c, a second interaction action indicated by the voice information is acquired based on the voice information.

In S222c, the virtual pet is controlled to conduct the second interaction action.

In this embodiment, the instruction information includes the voice information. The smart projection device may capture, using a sensor (for example, a microphone), the voice information (the instruction information) from the user, identify the voice information, acquire the second interaction action indicated by the voice information, and then control the virtual pet to conduct the corresponding second interaction action, such that the virtual pet may understand the user's words and interact with the user.

It may be understood that a corresponding relationship between the voice information and the second interaction action is preset; in the case that the voice information includes an action, the second interaction action may be the action in the voice information, for example, when the user says “Get down,” the second interaction action gets down; in the case that the voice information does not include the action, the second interaction action may be pre-defined according to the voice information, for example, when the user says “Hi, I'm back,” the virtual pet is awakened and runs to the door to greet comeback of user, and when the user says “Hi, it's time to eat,” the virtual pet runs to an eating place to eat its meal.

In this embodiment, the virtual pet is controlled by the voice identification to conduct the second interaction action indicated by the voice information, such that the virtual pet understands the user's words. This gives interest to the user.

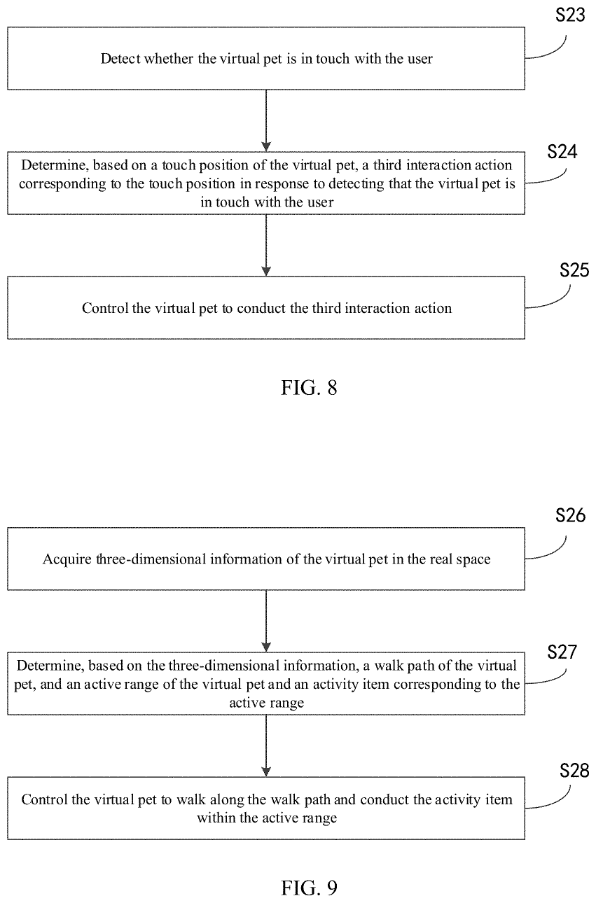

In some embodiments, referring to FIG. 8, the method further includes the following steps.

In S23, whether the virtual pet is in touch with the user is detected.

In S24, a third interaction action corresponding to the touch position is determined based on a touch position of the virtual pet in response to detecting that the virtual pet is in touch with the user.

In S25, the virtual pet is controlled to conduct the third interaction action.

In this embodiment, the smart projection device may capture, using a sensor (for example, a camera), an image of the user together with the virtual pet, and then perform target identification on the image. It may be understood the user and the virtual pet are identified using a conventional target identification algorithm (R-CNN, SSD, YOLO, or the like). A position of the user and a position of the virtual pet are determined, and a minimum distance between the user and the virtual pet is calculated. Whether the virtual pet is in touch with the user is detected according to the minimum distance between the user and the virtual pet. For example, in the case that the minimum distance between the user and the virtual pet is less than a preset value, it is determined that the user is in touch with the virtual pet. It may be understood that a contact part between the corresponding parts of the user and the virtual pet in the case of the minimum distance is the position at which the virtual pet is touched. For example, in the case that the distance between a user's hand and a virtual pet's head is the minimum distance, and the minimum distance is less than a preset threshold, the user's hand is in touch with the virtual pet's head, and the touch position of the virtual pet is the head.

The third interaction action corresponding to the touch position is determined according to the touch position of the virtual pet in response to detecting that the virtual pet is in touch with the user. It may be understood that a mapping relationship between the touch position and the third interaction action is preset in the smart projection device; and in the case that the touch position is determined by the target identification, the third interaction action corresponding to the touch position may be searched out, and then the virtual pet is controlled to conduct the third interaction action. For example, when the user touches the head of the virtual pet, the virtual pet may respond by actions of squinting and smiling seeming to be joyful (the corresponding third interaction action); when the user touches the tail of the virtual pet, the virtual pet may wag the tail (the corresponding third interaction action); and when the user touches a left front foot of the virtual pet, the virtual pet lifts the left front foot (the corresponding third interaction action).

In this embodiment, the virtual pet is controlled to conduct the third interaction action corresponding to the touch position by identifying the touch to realize touch interaction, such that the virtual pet has perceived reality.

In some embodiments, referring to FIG. 9, the method further includes the following steps.

In S26, three-dimensional information of the virtual pet in the real space is acquired.

In step S27, based on the three-dimensional information, a walk path of the virtual pet is determined, and an active range of the virtual pet and an activity item corresponding to the active range are determined.

In S28, the virtual pet is controlled to walk along the walk path and conduct the activity item within the active range.

In this embodiment, the smart projection device may capture, using a sensor (for example, at least one camera), an image of the real space, and acquire three-dimensional information of the real space by identifying the image, wherein the three-dimensional information includes shapes, sizes, and the like of various objects in the real space, and then, based on the three-dimensional information, determine the walk path of the virtual pet, for example, the walk path bypasses obstacles, for example, flowerpots, furniture, and the like. In this way, the virtual pet is controlled to walk along the walk path, such that the habits of the virtual pet are similar to those of a real pet, so as to increase the reality of the virtual pet.

It may be understood that the active range of the virtual pet and the activity item corresponding to the active range are determined based on the three-dimensional information. The virtual pet is set to do different things at different positions. For example, the active range of the virtual pet is set to include wall corners and vicinities of the window, the activity item corresponding to the wall corners may be sleeping, and the activity item corresponding to the vicinities of the window may be playing. In this way, in the case that the user reminds that the virtual pet needs to rest, the virtual pet is controlled to go to the wall corners to sleep; and in the case that the user indicates that the virtual pet needs to play, the virtual pet is controlled to play in the vicinities of the window. As such, the virtual pet is controlled to conduct a corresponding activity item within each activity range, the habits of the virtual pet are adapted to the environment and are more similar to the habits of the real pet, and the reality of the virtual pets is increased.

In this embodiment, the walk path of the virtual pet is planned according to the real environment of the real space, and the activity habits of the virtual pet are set, such that the habits of virtual pet are similar to that of the real pet, and the reality of the virtual pet is increased.

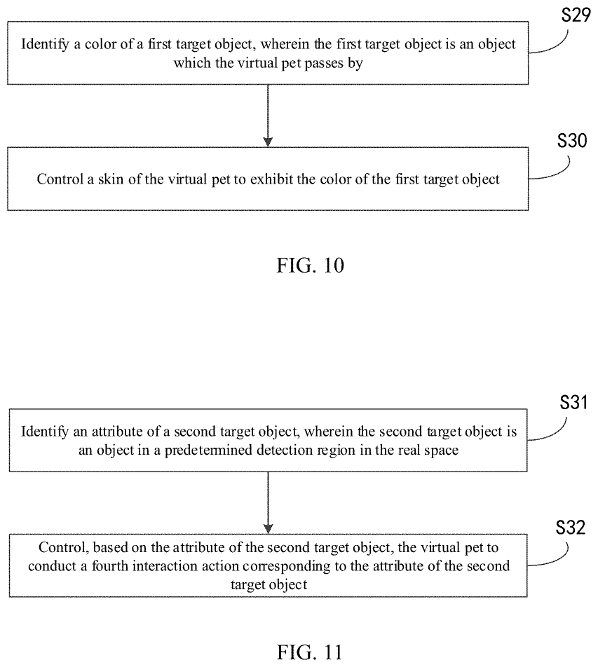

In some embodiments, referring to FIG. 10, the method further includes the following steps.

In S29, a color of a first target object is identified, wherein the first target object is an object which the virtual pet passes by.

In S30, a skin of the virtual pet is controlled to exhibit the color of the first target object.

In this embodiment, the smart projection device may also identify the color of the first target object which the virtual pet passes by. For example, when the virtual pet lizard crawls onto a wall, the color of the wall is detected; and when the virtual pet lizard crawls on the sill of the bay window, the color of the sill of the bay window is detected. Then, the skin of the virtual pet is controlled to exhibit the color of the first target object. For example, when the virtual pet lizard crawls onto a red wall, the skin color of the virtual pet lizard is controlled to turn red; and when the virtual pet lizard crawls onto a green object, the skin color of the virtual pet lizard is controlled to turn green.

In this embodiment, the skin is changed by controlling the color of the first target object which the virtual pet passes by, such that the virtual pet has a camouflage ability, and the interest is increased.

In some embodiments, referring to FIG. 11, the method further includes the following steps.

In S31, an attribute of a second target object is identified, wherein the second target object is an object in a predetermined detection region in the real space.

In S32, based on the attribute of the second target object, the virtual pet is controlled to conduct a fourth interaction action corresponding to the attribute of the second target object.

In this embodiment, the smart projection device may identify the attribute of the second target object in the predetermined detection region. For example, in the case that the user places a banana in the predetermined detection region, the smart projection device identifies the attribute of the banana as food and determines the position of the banana; or in the case that a ball is present in the predetermined detection region, the smart projection device identifies the attribute of the ball as a toy and determine the position of the ball. It may be understood that the predetermined detection region may be the region customized by the user, or may be a default region of the smart projection device.

It may be understood that a mapping relationship between the attribute of the second target object and the fourth interaction action is pre-stored in the smart projection device. In the case that the attribute of the second target object is determined, the fourth interaction action corresponding to the attribute of the second target object may be searched out, for example, food-eating, and toy-playing. In this way, the virtual pet is controlled to conduct the corresponding fourth interaction action, such that the interaction that the virtual pet eats food is realized in the case that the user places food in the predetermined detection region, and the interaction that the virtual pet crawls onto the toy to play with the toy is realized in the case that the virtual pet encounters a toy in the walk path.

In this embodiment, by controlling the virtual pet to conduct the fourth interaction action corresponding to the attribute of the second target object, the interactions between the virtual pet and surrounding objects may be realized, such that the behaviors of the virtual pet are more similar to behaviors of the real pet.

In summary, the method for controlling virtual pets according to the embodiments of the present disclosure is applicable to the smart projection device, and the smart projection device may project the virtual pets to the real space, display the same in a preset style, and may change different styles at will, such that the user may obtain the experience of raising different pets; and in addition, the smart projection device may also receive the instruction information from the user, and control the virtual pets to conduct corresponding interaction behaviors according to the instruction information, such that the interactions are more flexible and convenient, and the user may obtain a better experience and more pleasure and have an intimate pet accompanying sense.

An embodiment of the present disclosure further provides a non-volatile computer-readable storage medium storing at least one computer-executable instruction therein. The at least one computer-executable instruction, when executed by at least one processor, causes the processor to perform any of the methods for controlling the virtual pets as described above.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objects of the technical solutions of the embodiments.

According to the above embodiments of the present disclosure, a person skilled in the art may clearly understand that the embodiments of the present disclosure may be implemented by means of hardware or by means of software plus a necessary general hardware platform. Persons of ordinary skill in the art may understand that all or part of the steps of the methods in the embodiments may be implemented by a program instructing relevant hardware. The program may be stored in a computer-readable storage medium. When the program runs, the steps of the methods in the embodiments are performed. The storage medium may be any medium capable of storing program codes, such as a magnetic disk, a compact disc read-only memory (CD-ROM), a read-only memory (ROM), a random-access memory (RAM), or the like.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A method for controlling virtual pets, applicable to a smart projection device, the method comprising:
presetting a virtual pet, and controlling the smart projection device to project the virtual pet in a real space; and
receiving instruction information from a user, and controlling, based on the instruction information, the virtual pet to conduct a corresponding interaction behavior.

2. The method according to claim 1, wherein the instruction information comprises a user posture; and controlling, based on the instruction information, the virtual pet to conduct the corresponding interaction behavior comprises:
controlling the virtual pet to imitate the user posture.

3. The method according to claim 1, wherein the instruction information comprises a gesture; and controlling, based on the instruction information, the virtual pet to conduct the corresponding interaction behavior comprises:
determining, based on the gesture, a first interaction action corresponding to the gesture; and
controlling the virtual pet to conduct the first interaction action.

4. The method according to claim 1, wherein the instruction information comprises voice information; and controlling, based on the instruction information, the virtual pet to conduct the corresponding interaction behavior comprises:
acquiring, based on the voice information, a second interaction action indicated by the voice information; and
controlling the virtual pet to conduct the second interaction action.

5. The method according to claim 1, further comprising:
detecting whether the virtual pet is in touch with the user;
determining, based on a touch position of the virtual pet, a third interaction action corresponding to the touch position in response to detecting that the virtual pet is in touch with the user; and
controlling the virtual pet to conduct the third interaction action.

6. The method according to claim 1, further comprising:
acquiring three-dimensional information of the virtual pet in the real space;
determining, based on the three-dimensional information, a walk path of the virtual pet, and an active range of the virtual pet and an activity item corresponding to the active range; and
controlling the virtual pet to walk along the walk path and conduct the activity item within the active range.

7. The method according to claim 6, further comprising:
identifying a color of a first target object, wherein the first target object is an object which the virtual pet passes by; and
controlling a skin of the virtual pet to exhibit the color of the first target object.

8. The method according to claim 6, further comprising:
identifying an attribute of a second target object, wherein the second target object is an object in a predetermined detection region in the real space; and
controlling, based on the attribute of the second target object, the virtual pet to conduct a fourth interaction action corresponding to the attribute of the second target object.

9. A smart projection device, comprising:
a projecting unit, configured to project a virtual pet to a real space;
a rotating unit, configured to control the projecting unit to rotate to control the virtual pet to move in the real space;
a sensor assembly, configured to acquire instruction information from a user and acquire three-dimensional information of the real space;
at least one processor, communicably connected to the projecting unit, the rotating unit, and the sensor assembly; and
a memory communicably connected to the at least one processor; wherein the memory stores one or more instructions executable by the at least one processor, wherein the one or more instructions, when executed by the at least one processor, cause the at least one processor to perform the method as defined in claim 1 based on the instruction information and the three-dimensional information of the real space.

10. A non-volatile computer-readable storage medium storing one or more computer-executable instructions, wherein the one or more computer-executable instructions, when executed by at least one processor, cause the at least one processor to perform the method as defined in claim 1.
